(19) United States
(12) Patent Application Publication
(10) Pub. No.: US 2023/0028611 A1
(43) Pub. Date: Jan. 26, 2023

(54) COMPUTERIZED SYSTEMS AND METHODS FOR A USER-ASSOCIATED ELECTRONIC BADGE

(71) Applicant: SONG MATES, INC., Columbia City, IN (US)

(72) Inventors: Katina Houser, Columbia City, IN (US); Richard Forbes Taylor, Stamford, CT (US); Caitlin Alexander, Greeley, CO (US)

(21) Appl. No.: 17/871,673

(22) Filed: Jul. 22, 2022

Related U.S. Application Data
(60) Provisional application No. 63/224,668, filed on Jul. 22, 2021.

(51) Int. Cl. G07C 9/27; G07C 9/28; G06Q 10/02

(52) U.S. Cl. CPC G07C 9/27; G07C 9/28; G06Q 10/02

(57) ABSTRACT

The disclosed system provides a novel framework that includes an on-device electronic badge configured with presence broadcasting, monitoring, and communication platforms for interaction with other on-device and networked applications and badges. The disclosed badge can be configured to be dynamically generated (or assembled) based on a set of identifying information related to the user. A generated badge can be utilized to interact with other users and/or interact with activities at particular events, which can occur in the digital realm (e.g., online) or in/at physical locations. A badge can also further be utilized for receiving recommended content.

### CROSS-REFERENCE TO RELATED APPLICATION

This application claims the benefit and priority to U.S. Provisional Application No. 63/224,668, filed Jul. 22, 2021, the entire contents of which are incorporated herein by reference.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to a mechanism for generating an electronic identifier for a user; and more particularly, to providing an on-device electronic badge configured with presence broadcasting, monitoring, and communication mechanisms for interaction with other on-device and/or networked applications and badges.

### BACKGROUND

Conventional techniques for identifying a user and/or indicating a user is present at a location fall short of dynamically representing a user and/or his, her or their true or requested identity. Indeed, conventional mechanisms are tied to management and usage of profile information from social applications that dictate how a device handles push notifications or alerts.

### SUMMARY

The disclosed systems and methods provide a novel framework that addresses these shortcomings, among others, by providing an on-device, interactive electronic badge. According to some embodiments, the badge is configured to be dynamically generated (or assembled) based on a set of identifying information related to the user. In some embodiments, as discussed below, the identifying information includes one or more of demographics, biometrics, geographic information, and/or any other type of information that can be utilized to reference a person and/or the person's interests and/or other preferences/settings.

By way of a non-limiting example, according to some embodiments, the identifying information corresponds to, but is not limited to, one or more of gender identity, gender expression, gender orientation, pronouns, sexuality, race, heritage, age, relationship status, location, media preferences (e.g., tastes in music, movies, books, television, and the like, or some combination thereof), media history or behaviors (e.g., what music is in your playlist(s), what song did you listen to on a first date, and the like), biometric data (e.g., eye color, pulse and/or heart rate, fingerprints, face ID, and the like), security settings, types of devices used, and the like, or some combination thereof.

In some embodiments, the information used to generate or assemble a badge for a user is provided by the user (or in some embodiments, at least a portion of the information provided by the user); and in some embodiments, such information (or at least a portion of the information) can be derived from a user's profile, where the profile can be associated with a proprietary application or platform providing the badge functionality or a third party profile (e.g., a user'social networking profile, such as, for example, Facebook®).

According to some embodiments, a first electronic device is configured to use a generated badge to announce a user's presence at a location. In some embodiments, the badge is configured to send out a signal (e.g., Bluetooth™, Bluetooth Low Energy (BLE), or Near-Field Communication (NFC) functionality, for example) via the sending electronic device to one or more second electronic devices configured to receive the signal (e.g., electronic devices comprising an instance of the badge, devices enabled with Bluetooth™, Bluetooth Low Energy (BLE), or Near-Field Communication (NFC) functionality, as non-limiting examples). In some embodiments, the signal is configured to enable the one or more second electronic devices to identify a user, identify user information, and/or identify sending device information associated with the badge on the first electronic device. According to some embodiments, a location can be a real-world location and/or a digital environment, (e.g., a webpage, portal, or virtual reality (VR) or augmented reality (AR) or mixed reality (XR) environment).

In some embodiments, the badge is configured to enable a user to interact with other users and/or interact with activities at particular events. In some embodiments, the badge is configured identify and/or generate a match notification of one or more users that have similar interests (e.g., music, hobbies, etc.). In some embodiments, the badge is configured locate and/or generate a location notification of one or more users that have similar interests. In another example, the badge is configured display a location of other similarly interested users at an event on a map. In some embodiments, the badge is configured to identify and/or create a geo-fence defining a perimeter at a location (e.g., location and time surrounding an event at a particular physical and/or virtual location). In some embodiments, the geo-fence includes a mobile geo-fence defining a perimeter around the user that moves with the user (e.g., a predefined radius). In some embodiments, the badge is configured to identify other users within the geo-fence. In some embodiments, the badge is configured to communicate (e.g., send and receive signals) with one or other badges on one or more other electronic devices. In some embodiments, the badge is configured to receive content and/or recommendations. In some embodiments, the badge is configured to enable a user to accepting a recommended activity (e.g., play a song, go to this location because other similar users are congregating there, and the like).

In accordance with one or more embodiments, the present disclosure provides computerized methods for a novel framework that provides an on-device electronic badge configured with presence broadcasting, monitoring, and communication mechanisms for interaction with other on-device and/or networked applications and badges.

In accordance with one or more embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device (e.g., a client device) cause at least one processor to perform a method for a novel and improved framework that provides an on-device electronic badge configured with presence broadcasting, monitoring, and communication mechanisms for interaction with other on-device and/or networked applications and badges.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments are embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating an example of client device in accordance with some embodiments of the present disclosure;

FIG. 3 is a block diagram illustrating components of an exemplary system in accordance with some embodiments of the present disclosure;

FIG. 4 is a block diagram illustrating an exemplary data flow in accordance with some embodiments of the present disclosure;

FIG. 5 illustrates a non-limiting electronic badge displayed within a user interface (UI) on a device in accordance with some embodiments of the present disclosure;

FIG. 6 is a block diagram illustrating an exemplary data flow in accordance with some embodiments of the present disclosure; and

FIG. 7 is a block diagram illustrating an exemplary data flow in accordance with some embodiments of the present disclosure.

### DESCRIPTION OF EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th}, or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an NFC device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

As discussed herein, reference to an “advertisement” should be understood to include, but not be limited to, digital media content embodied as a media item that provides information provided by another user, service, third party, entity, and the like. Such digital ad content can include any type of known or to be known media renderable by a computing device, including, but not limited to, video, text, audio, images, and/or any other type of known or to be known multi-media item or object. In some embodiments, the digital ad content can be formatted as hyperlinked multi-media content that provides deep-linking features and/or capabilities. Therefore, while some content is referred to as an advertisement, it is still a digital media item that is renderable by a computing device, and such digital media item comprises content relaying promotional content provided by a network associated party.

As discussed in more detail below, according to some embodiments, information associated with, derived from, or otherwise identified from, during or as a result a generation of a badge and/or usage of a badge during an event, as discussed herein, can be used for monetization purposes and targeted advertising when providing, delivering, or enabling such devices access to content or services over a network. Providing targeted advertising to users associated with such discovered content can lead to an increased click-through rate (CTR) of such ads and/or an increase in the advertiser's return on investment (ROI) for serving such content provided by third parties (e.g., digital advertisement content provided by an advertiser, where the advertiser can be a third party advertiser, or an entity directly associated with or hosting the systems and methods discussed herein).

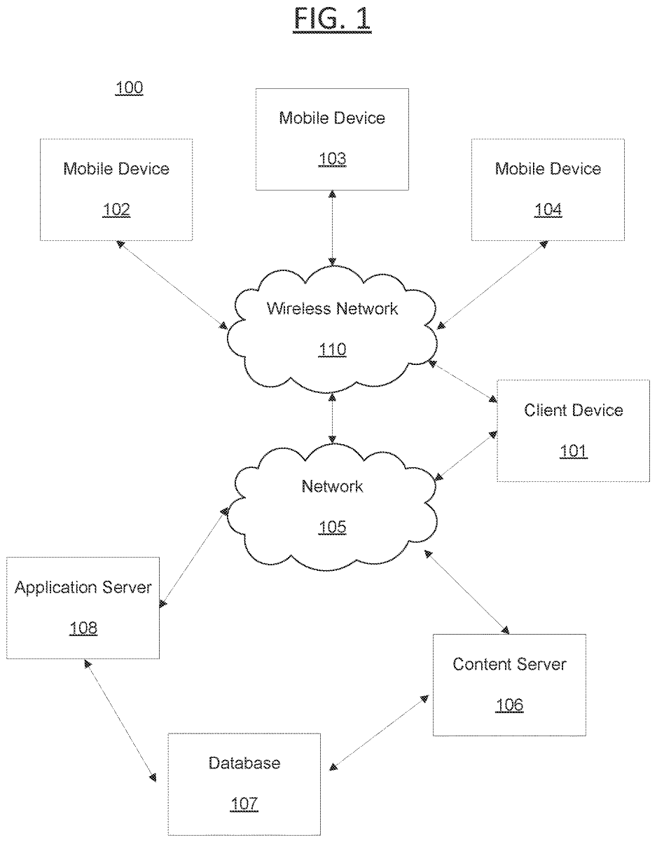

Some embodiments will now be described in greater detail with reference to the figures. In general, with reference to FIG. 1, a system 100 in accordance with some embodiments of the present disclosure are shown. FIG. 1 shows components of a general environment in which the systems and methods discussed herein may be practiced. In some embodiments, not all the components may be required to practice the disclosure, and variations in the arrangement and type of the components may be made without departing from the spirit or scope of the disclosure. In some embodiments, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106 and application (or “App”) server 108 according to some embodiments.

Some embodiments of mobile devices 102-104 may include virtually any portable computing device capable of receiving and sending a message over a network, such as network 105, wireless network 110, or the like. In some embodiments, mobile devices 102-104 may also be described generally as client devices that are configured to be portable. In some embodiments, mobile devices 102-104 may include virtually any portable computing device capable of connecting to another computing device and receiving information, as discussed above.

In some embodiments, mobile devices 102-104 also may include at least one client application that is configured to receive content from another computing device. In some embodiments, mobile devices 102-104 are configured to communicate with non-mobile client devices, such as client device 101, or the like. In some embodiments, such communications may include the badge sending and/or receiving messages, searching for, viewing and/or sharing memes, photographs, digital images, audio clips, video clips, or any of a variety of other forms of communications.

In some embodiments, client devices 101-104 may be capable of sending or receiving signals, such as via a wired or wireless network, or may be capable of processing or storing signals, such as in memory as physical memory states, and may, therefore, operate as a server.

In some embodiments, wireless network 110 is configured to couple mobile devices 102-104 and its components with network 105. In some embodiments, wireless network 110 may include any of a variety of wireless sub-networks that may further overlay stand-alone ad-hoc networks, and the like, to provide an infrastructure-oriented connection for mobile devices 102-104.

In some embodiments, network 105 is configured to couple content server 106, application server 108, or the like, with other computing devices, including, client device 101, and through wireless network 110 to mobile devices 102-104. In some embodiments, network 105 is enabled to employ any form of computer readable media or network for communicating information from one electronic device to another.

In some embodiments, the content server 106 may include a device that includes a configuration to provide any type or form of content via a network to another device. In some embodiments, devices that may operate as content server 106 include personal computers, desktop computers, multiprocessor systems, microprocessor-based or programmable consumer electronics, network PCs, servers, and the like. In some embodiments, content server 106 can further provide a variety of services that include, but are not limited to, email services, instant messaging (IM) services, streaming and/or downloading media services, advertising services, proximity services, search services, photo services, web services, social networking services, news services, third-party services, audio services, video services, SMS services, MMS services, FTP services, voice over IP (VOIP) services, or the like.

In some embodiments, content server 106 can be, or may be coupled or connected to, a third-party server that stores online advertisements for presentation to users. In some embodiments, various monetization techniques or models may be used in connection with sponsored advertising, including advertising associated with user data, as discussed below, where ads can be modified and/or added to content based on the personalization of received content using the locally accessible user profile.

In some embodiments, badge users are able to access services provided by servers 106 and/or 108. In some embodiments, this may include in a non-limiting example, authentication servers, search servers, email servers, social networking services servers, SMS servers, IM servers, MMS servers, exchange servers, photo-sharing services servers, and travel services servers, via the network 105 using their various devices 101-104.

In some embodiments, applications, such as, but not limited to, news applications (e.g., ESPN®, Huffington Post®, CNN®, and the like), mail applications (e.g., Yahoo! Mail®, Gmail®, and the like), instant messaging applications, blog, photo, or social networking applications (e.g., Facebook®, Twitter®, Instagram®, and the like), search applications (e.g., Google Search®), and the like, can be hosted by the application server 108, or content server 106 and the like.

Thus, the application server 108 and/or content server 106, for example, can store various types of applications and application related information including application data and other various types of data related to the content and services in an associated content database 107, as discussed in more detail below in accordance with some embodiments. Some embodiments exist where the network 105 is also coupled with/connected to a Trusted Search Server (TSS) which can be utilized to render content in accordance with the embodiments discussed herein. In some embodiments, the TSS functionality can be embodied within servers 106 and/or 108.

In some embodiments, although FIG. 1 illustrates servers 106 and 108 as single computing devices, respectively, the disclosure is not so limited. In some embodiments, one or more functions of servers 106 and/or 108 may be distributed across one or more distinct computing devices. In some embodiments, servers 106 and/or 108 may be integrated into a single computing device, without departing from the scope of the present disclosure.

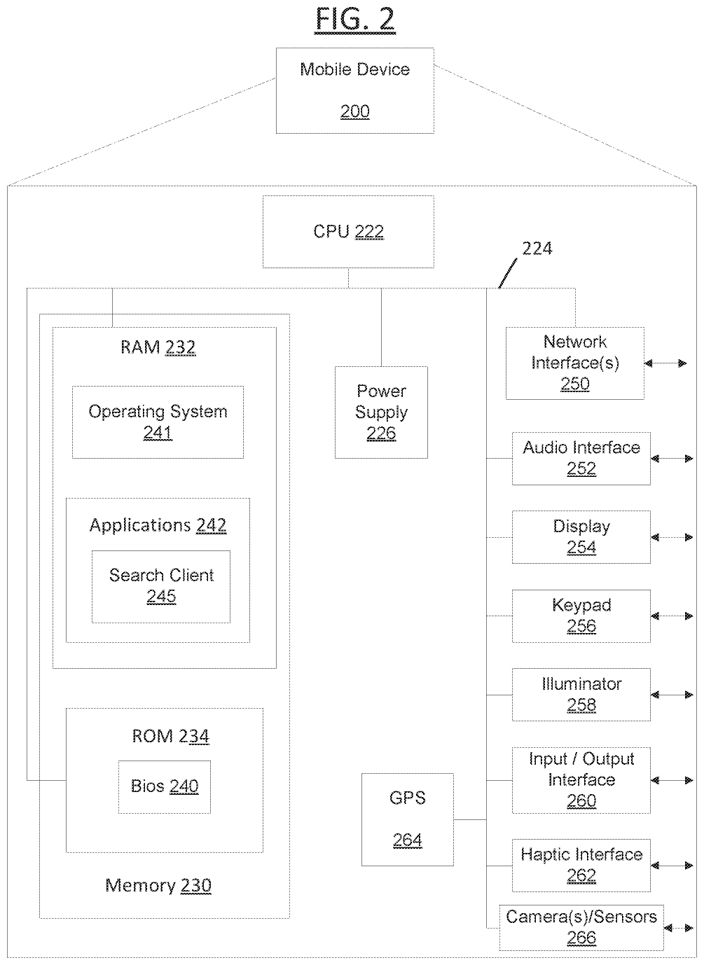

FIG. 2 is a schematic diagram illustrating a client device showing an example embodiment of a client device that may be used within the present disclosure according to some embodiments. In some embodiments, client device 200 may include many more or less components than those shown in FIG. 2. However, in some embodiments, the components shown are sufficient to disclose an illustrative embodiment for implementing the present disclosure. In some embodiments, client device 200 may represent, for example, client devices 101-104 discussed above in relation to FIG. 1.

In some embodiments, client device 200 includes a processing unit (CPU) 222 in communication with a mass memory 230 via a bus 224. In some embodiments, client device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and a camera(s) or other optical, thermal, or electromagnetic sensors 266. In some embodiments, client device 200 can include one camera/sensor 266, or a plurality of cameras/sensors 266, as understood by those of skill in the art. Power supply 226 provides power to Client device 200.

In some embodiments, client device 200 may optionally communicate with a base station (not shown), or directly with another computing device. In some embodiments, network interface 250 is sometimes known as a transceiver, transceiving device, or network interface card (NIC).

In some embodiments, the badge is configured to communicate with an audio interface 252 configured to produce and/or receive audio signals such as, for example, the sound of a human voice. In some embodiments, display 254 can, but is not limited to, a include a touch sensitive screen arranged to receive input from an object such as a stylus or a digit from a human hand. In some embodiments, keypad 256 can comprise any input device arranged to receive input from a user. In some embodiments, illuminator 258 may provide a status indication and/or provide light.

In some embodiments, client device 200 also comprises input/output interface 260 for communicating with external devices. Input/output interface 260 can utilize one or more communication technologies, such as USB, infrared, BluetoothTM, or the like. In some embodiments, haptic interface 262 is arranged to provide tactile feedback to a user of the client device.

Some embodiments include a global positioning system (GPS) transceiver 264 configured determine the physical coordinates of client device 200 on the surface of the Earth. In some embodiments however, client device 200 may through other components, provide other information to a badge that may be employed to determine a physical location of the device, including for example, a MAC address, Internet Protocol (IP) address, or the like.

In some embodiments, mass memory 230 includes a RAM 232, a ROM 234, and other storage means. In some embodiments, mass memory 230 stores a basic input/output system (“BIOS”) 240 for controlling low-level operation of Client device 200. The mass memory also stores an operating system 241 for controlling the operation of Client device 200

In some embodiments, memory 230 further includes one or more data stores, which can be utilized by client device 200 to store, among other things, applications 242 and/or other information or data. For example, in some embodiments, data stores may be employed to store information that describes various capabilities of client device 200. In some embodiments, the information may then be provided to another electronic device and/or badge based on any of a variety of events, including being sent as part of a header (e.g., index file of the HLS stream) during a communication, sent upon request, or the like. In some embodiments, at least a portion of the capability information may also be stored on a disk drive or other storage medium (not shown) within client device 200.

In some embodiments, applications 242 may include computer executable instructions which, when executed by client device 200, transmit, receive, and/or otherwise process audio, video, images, and enable telecommunication with a server and/or another client device. In some embodiments, applications 242 may further include search client 245 that is configured to send, to receive, and/or to otherwise process a search query and/or search result.

Having described the components of the general architecture employed within the disclosed systems and methods, the components' general operation with respect to the disclosed systems and methods will now be described below.

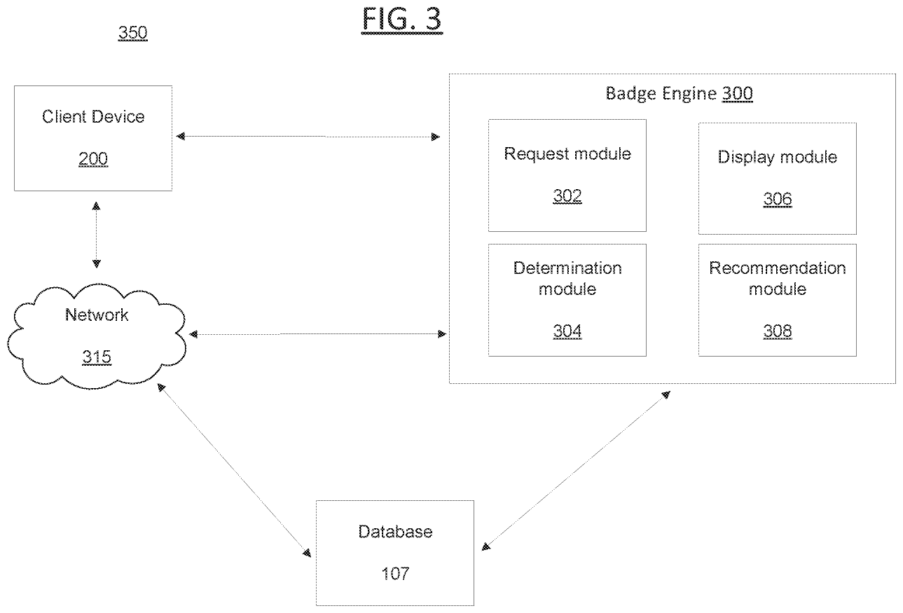

FIG. 3 is a block diagram illustrating the components for performing the systems and methods discussed herein according to some embodiments. FIG. 3 depicts system 350 which includes, in some embodiments, client device 200, badge engine 300, network 315 and database 107.

According to some embodiments, badge engine 300 can be a special purpose machine or processor and could be hosted by device 200. In some embodiments, badge engine 300 is configured hosted by an electronic device coupled to device 200. For example, an electronic device includes, but is not limited to, one or more of another mobile device, a transceiver, a RFID tag, a display screen, wearable clothing or technology (e.g., smartwatch) and/or any other type of device that can be coupled to another device that functions as a single device, connected device configuration and/or Internet of Things (IoT) device configuration, and/or via any other type of known or to be known communication technique for devices to interact (e.g., NFC and/or IR, for example).

According to some embodiments, badge engine 300 can function as, or be associated with an application installed on (electronic) device 200, and in some embodiments, such application can be a web-based application accessed by device 200 over network 315. In some embodiments, badge engine 300 is configured and/or installed as an augmenting script, program, or application (e.g., a plug-in or extension) to another application or portal data structure. In some embodiments, badge engine 300 can be hosted by a server on network 315, that is accessible by user electronic devices and/or providing information for users for display on their electronic devices.

In some embodiments, the database 107 can be any type of database or memory and can be associated with a server on a network 315 (e.g., content server, a search server or application server) or a user's device (e.g., device 101-104 or device 200 from FIGS. 1-2). In some embodiments, database 107 comprises a dataset of data and metadata associated with local and/or network information related to users, services, applications, content, and the like.

In some embodiments, such information can be stored and indexed in the database 107 independently and/or as a linked or associated dataset. In some embodiments, an example of this is look-up table (LUT). As discussed above, it should be understood that the data (and metadata) in the database 107 can be any type of information and type, whether known or to be known, without departing from the scope of the present disclosure.

According to some embodiments, database 107 can store user data associated with one or more badges. According to some embodiments, the stored user data can include, but is not limited to, information associated with a user's profile, user interests, user behavioral information, user patterns, user attributes, user preferences or settings, user demographic information, user location information, user biographic information, and the like, or some combination thereof

In some embodiments, the user data can also include user device information, including, but not limited to, device identifying information, device capability information, voice/data carrier information, Internet Protocol (IP) address, applications installed or capable of being installed or executed on such device, and/or any, or some combination thereof. It should be understood that the data (and metadata) in the database 107 can be any type of information related to a user, content, a device, an application, a service provider, a content provider, whether known or to be known, without departing from the scope of the present disclosure.

According to some embodiments, database 107 can store data and metadata associated with users, searches, actions, renderings, clicks, conversions, previous recommendations, messages, images, videos, text, products, items, and services from an assortment of media, applications and/or service providers and/or platforms, and the like. In some embodiments, any type of known or to be known attribute or feature associated with a user, message, data item, media item, login, logout, event attendance, website, application, communication (e.g., a message) and/or its transmission over a network, a user and/or content included therein, or some combination thereof, can be saved as part of the data/metadata associated with a badge in datastore 107.

In some embodiments, with reference to FIG. 1, the network 315 can be any type of network such as, but not limited to, a wireless network, a local area network (LAN), wide area network (WAN), the Internet, or a combination thereof. In some embodiments, the network 315 facilitates connectivity of the badge engine 300, and the database of stored resources 107. In some embodiments, as illustrated in FIG. 3, the badge engine 300 and database 107 can be directly connected by any known or to be known method of connecting and/or enabling communication between such devices and resources.

In some embodiments, the principal processor, server, or combination of devices that comprise hardware programmed in accordance with the special purpose functions herein is referred to for convenience as a badge, a badge engine 300, and/or the system, and includes request module 302, determination module 304, display module 306 and recommendation module 308. It should be understood that the engine(s) and modules discussed herein are non-exhaustive, as additional, or fewer engines and/or modules (or sub-modules) may be applicable to the embodiments of the systems and methods discussed. The operations, configurations and functionalities of each module, and their role within some embodiments of the present disclosure will be discussed below.

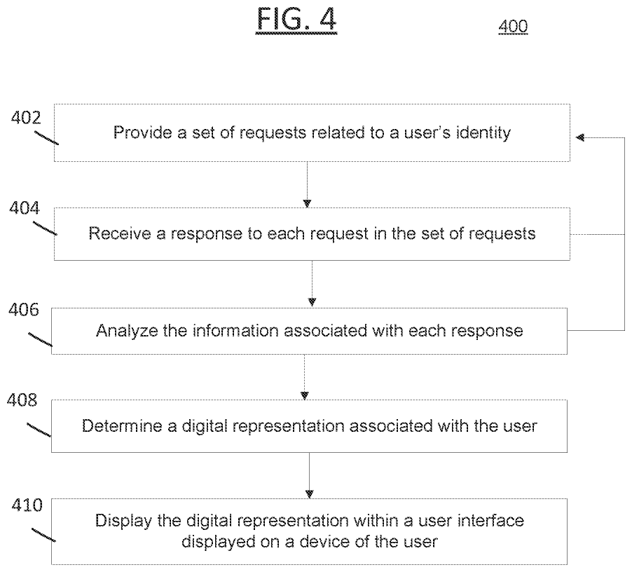

Turning to FIG. 4, process 400 details a workflow for generating or assembling an electronic badge for a user according to some embodiments. In some embodiments, steps 402-404 can be performed by request module 302 of badge engine 300. In some embodiments, steps 406-408 can be performed by determination module 304. In some embodiments, step 410 can be performed by display module 308.

Process 400 begins with step 402 where the badge is configured to generate a data requests related to a user's identity according to some embodiments. In some embodiments, the data requests include questions and/or requests for identifying information related to a user. In some embodiments, the badge is configured to enable a user to enter information related to the data request. In some embodiments, the badge is configured to provide a selectable array of information for a user to choose from, which can be selected by any type of input, such as, but not limited to, a swipe, pinch, touch, force-touch, voice-input, eye-tracking, and the like, and/or any other type of input that known or to be known devices recognize as input or selection of an interface object displayed on a screen.

In some embodiments, the badge is configured to execute a (automatic) “scraping” of a user's profile (e.g., badge profile, third party social media profile) to retrieve the desired information. In some embodiments, the user profile is associated with an application providing the badge functionality (e.g., an application associated with badge engine 300); and in some embodiments, the user profile is associated with a third party application (e.g., a user's social media profile).

In some embodiments, the data requests are predefined. In some embodiments, the data requests are determined based on initial (or seed) piece of information. For example, if the user indicates his/her name (or engine 300 detects a type of device or location of the user), then the next question can be determined based on this information.

In step 404, a response for each request from step 404 is received according to some embodiments. In some embodiments, the response(s) can be entered by a user or be entered by selection from an array of choices or options. In some embodiments, the response(s) are automatically retrieved from a user profile of the user.

In some embodiments, the interplay between steps 402 and 404 can be recursive in that a request is provided (step 402) and a response is received (Step 404), and process 400 proceeds back to step 402 to ask another request. In some embodiments, a threshold satisfying number of recursive iterations between steps 402-404 can be performed before process 400 proceeds to step 406.

In some embodiments, a user may decline to answer certain questions or requests. Therefore, in some embodiments, another question may be retrieved or compiled, or another set of questions may be retrieved/compiled until a threshold amount of information about a user is collected.

By way of a non-limiting example of steps 402-404, process 400 can present a set of interactive options for a user to sequentially identify their gender identity, expression, orientation, and preferred pronouns.

According to some embodiments, each selected or provided response can correspond to and/or provide a specific type of information for formation of a digital representation (or badge ID). In some embodiments, the user can be enabled to provide a form of user-generated content (UGC) in response to a request. According to some embodiments, for example, a response can correspond to a symbol, color, shade, pattern, shape, image, video or video frame, multi-media object (e.g., graphics interchange file (GIF)), icon, and/or other type of representations that enables a user and/or application to discern information related to a user's identity.

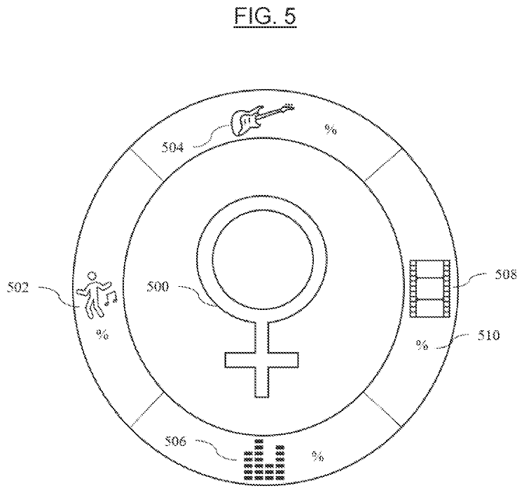

Turning to FIG. 5, which provides a non-limiting example of a compiled badge display displayed within a graphical user interface (GUI) of a (electronic) device 510 (e.g., device 200 as in FIG. 2) according to some embodiments. In some embodiments, the GUI of device 510 can be associated with a proprietary application providing badge functionality. According to embodiments of the instant disclosure, the non-limiting example badge display has components 500-508, which should not be construed that such components are limiting, as one of skill in the art would understand that variations in the color schemes, icons, patterns, orientations, configuration, and arrangement can be employed without departing from the scope of the instant disclosure.

The example badge display in FIG. 5 according to some embodiments illustrates a depiction of responses provided by a user. In some embodiments, the badge is configured to generate a badge display based on the answers provided by the user. In some embodiments, the generated badge display relates to one or more of the user's gender identity, expression, orientation, and preferred pronouns. For example, in some embodiments, gender identity can be indicated by a first icon 500; expression can be indicated by a second icon 502; orientation can be indicated by third icon 504; and pronouns can be indicated by fourth 506. In some embodiments, the badge is configured to consolidate the badge display into a single and/or continuous image as shown in FIG. 5.

In some embodiments, an icon 508 may represent liked movies. In some embodiments, icons 500 and/or 508 can also be an area for a user to input UGC (e.g., a profile picture or a topic icon for example).

In some embodiments, the icons of 502-508, and/or icons 500-508 can represent an identity attribute or feature. For example, icons 502-506 can provide a digital representation of a user's orientation.

In another non-limiting example, the icons the badge in FIG. 5 can further or alternatively display interest settings for a user. In some embodiments, the icons 502-508 are configured to link and or direct a user to additional information. In some embodiments, additional information includes music interests and music history of the user. In some embodiments, this may include which songs or genres of songs the user was interested in presently or at some time in the past. As a non-limiting example, icon 502 representing past music preferences links to a list of love songs from high school, while icon 504 can represent and/or link to past pop music from college, icon 506 can represent and or link to electronic music tastes of the present time, and icon 508 can link to a list of favorite movies. Thus, for example, the color coding and/or shape of each icon 502-508 can indicate a music interest and be predefined accordingly. For examples, an icon shape may include a guitar for rock bands, or a heart for love songs, a sad emoji for sad movies, etc.).

In some embodiments, the system is configured to generate a badge display specific to an event. In some embodiments, the badge is configured to display an overlap percentage 510 which shows a percentage of overlap with a second electronic device user in a same category. In some embodiments, election of an icon and or area of the badge display is configured to generate a list of overlapping interests with another user. In some embodiments, the badge is configured to generate a notification when one or more interest overlaps past a pre-determined setpoint.

Turning back to FIG. 4, process 400 proceeds from step 404 to step 406 where the information retrieved in step 404 is analyzed. According to some embodiments, the analysis performed by badge engine 300 in step 406 can be performed by any known or to be known computational analysis technique including one or more artificial intelligence (AI) classifiers, algorithms, mechanisms or technology, including, but not limited to, computer vision, neural networks, machine learning, cluster analysis, data mining, vector search engines, Bayesian network analysis, Hidden Markov models, logical models and/or tree analysis, and the like.

In some embodiments, step 406 is performed each time a response is provided. In some embodiments, step 406 can be performed on the whole or a portion of the set of responses from step 404 (e.g., wait until the threshold satisfying number of answers is provided, then proceed to performing the analysis). In some embodiments, step 406 indicates whether the threshold is satisfied, whereby further requests as in step 402 are provided based on step 406 analysis (as indicated by the arrow from step 406 to step 402).

In step 408, a determination of a badge display associated with a user is provided, which is based on analysis from step 406. As discussed above, the badge display (digital representation, badge identifier (ID) or ID, are used interchangeably) provides a visible display for a viewing user and/or application (or camera or sensor) to view and discern/determine characteristics of a user's identity. According to some embodiments, portions of the badge can be annotated with metadata that applications, sensors, or cameras can detect when analyzing the badge so as to identify the information being presented within the badge. For example, a badge can be encoded with GPS data to indicate a user's current location.

In Step 410, the badge display generated/assembled in step 408 is displayed on an electronic device of a user. An example of this is illustrated in FIG. 5, as discussed above.

According to some embodiments, privacy settings can be set by a user and/or dynamically determined and applied by badge engine 300 based on profile information of the user that control how much, if any, information related to a user's badge can be displayed to other users. For example, if a user is not “friends” with other users, or if they are not at the same event, then the user's badge may not be viewable, or only a portion of the data may be viewable. For example, if a user is at an event at a location, that user's badge may be modified to display a symbol rather than their profile picture, and other users may view their gender identity symbol rather than their profile picture, at least until a “friend” relationship is established, as discussed below.

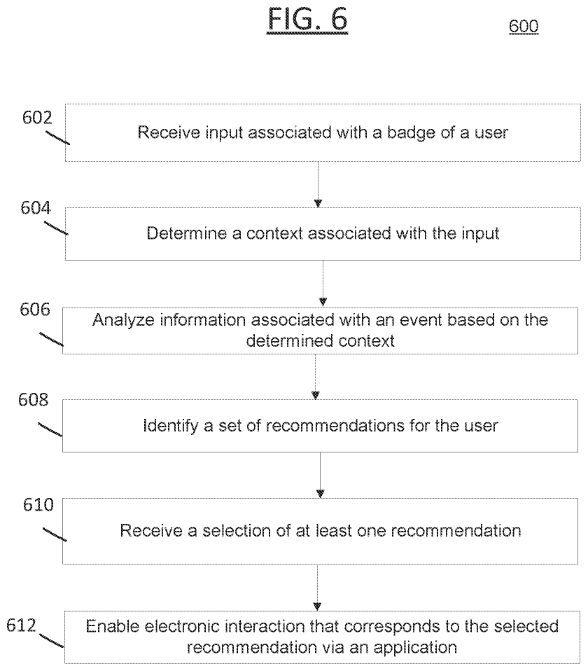

In FIG. 6, Process 600 details non-limiting example embodiments for utilizing a badge to interact with other users, interact with activities at an event and/or interact with and/or receive content, recommendations and/or render content.

According to some embodiments, an event can be associated with a real-world location (e.g., a set of streets or proximate location to a parade, a location associated with a gathering of individuals, and the like). In some embodiments, an event is associated with a network location (e.g., a website, portal, or chat room where users congregate online and interact). In some embodiments, an event has both digital and real-world affiliations where a set of users at a physical location can be granted access to a chat room where they can interact digitally. In some embodiments, an event can be a VR or AR experience, which can occur over a network and/or at a physical location(s).

According to some embodiments, step 602 can be performed by request module 302 of badge engine 300; step 604 can be performed by determination module 304; and steps 606-612 can be performed by recommendation module 308.

Process 600 begins with step 602 where input associated with a user's badge is received. The input can correspond to an event, which as discussed above, can be an activity or set of activities occurring in the real-world and/or digital realm.

In some embodiments, the input can be a user interacting with a badge (e.g., providing touch input to a badge icon) and/or an application on an electronic device providing the badge, which triggers a signal to be transmitted to other user devices. For example, a user can enter a location (e.g., a park where an event is occurring), and the user's badge can send out a signal indicating their presence. In some embodiments, the signal is received by another electronic device. In some embodiments, the electronic device is a central electronic device configured to receive and/or broadcast a signal from a plurality of electronic devices. In some embodiments, an input request from the badge is one or more of automatically occurring (e.g., periodically triggered) and in response to a request by the user and/or other user's badge notifications. In some embodiments, the input request is automatically triggered based on profile information of a user, for example, based on calendar information that indicates the user is going to be at a location at a specific time. In some embodiments, the badge is configured to broadcast the signal at that time. In some embodiments, the system is configured to determine if the user is at the predetermined location before broadcasting the signal. In some embodiments, the input request and/or notification is based on one or more of a command, an automatically detected criteria being satisfied, and/or a proximity detection to a time or location.

In step 604, the input is analyzed, and a context associated with the input can be determined. In some embodiments, the analysis performed in step 604 is similar to the computational analysis performed for step 406 of process 400 of FIG. 4, as discussed above.

In some embodiments, the context corresponds to a type of information that relates to the input request from step 602. In some embodiments, the context can relate to, but is not limited to, identification of other users with similar interests, identification of other users with similar intent (e.g., looking for dates and/or building relationships), identification of other users with similar identities, identification of users with similar musical backgrounds/histories, identification of users within a predetermined geographical area (e.g., geo-fenced, within a same geographical location such as home city or state), identification of users currently at a location, identification of types of content (e.g., requesting suggestions for music to listen to that can be based on an attended event or other criteria indicating spatial, temporal and/or logical relationships to a current environment, and the like), or some combination thereof.

In step 606, information associated with the event can be identified and utilized as a basis for analyzing the determined context from step 604. In other words, an event (and its associated information) can be analyzed based on the determined context. The analysis performed in step 606 is similar to the computational analysis performed in steps 604 (and step 404), as discussed above.

In some embodiments, the event information is identified in step 602, or in response to the input. In some embodiments, the event information indicates, but is not limited to, a number of users/participants at an event, user identity or badge information, a number and/or type of activities at an event, a time of the event, location of the event, real-world and digital security settings of the event, and the like, or some combination thereof.

Thus, in step 608, the analysis performed by engine 300 in step 606 can result in a set of recommendations that are responsive to the input received in step 602. These recommendations, as discussed above, can identify other users, other badges, content/media, activities, and the like (e.g., recommendations that are responsive to context of the user's input requests), or some combination thereof.

In some embodiments, the set of recommendations determined, retrieved, derived, or otherwise identified in step 608 can be displayed on a display of the user's device. In some embodiments, an application associated with engine 300 can display a pop-up window, sidebar, annotated screen, augmented screen or display (e.g., VR/AR), another window or tab, or other form of displayable objects that enables the review and selection of each recommendation. In some embodiments, when badge engine 300 provides the recommendations, a notification is provided to the user, such as, but not limited to, a haptic effect on the user's device, a sound notification or other form of audible, visible or physical output related to the user's device (or application executing thereon that is providing badge functionality, as discussed herein). In some embodiments, recommendations are communicated as messages to other third-party applications or platforms (e.g., as messages in an inbox, for example).

In some embodiments, a recommendation causes a recommended user's badge (e.g., a badge of another user that has similar interests to the user's badge) and/or the user's badge to be modified to indicate that a match has occurred, and in some embodiments, to what degree (e.g., value, percentage) such match is enabled. In some embodiments, the badge of the user and/or (other) matching user(s) are displayed in a manner that indicates a level of match according to a predetermined range. For example, if user X matches user Y, as they have similar tastes in music and the same orientation, then a scaled indicator appears on the badges of one or more users (at least the matching user's badge that is displayed on the user's device UI) that indicates the level of matching. In some embodiments, for example, the indicator can occupy the space of icons 502-506 and display a match level by a filled in amount of the indicator (e.g., a gauge that is filled according to a match level). For example, if they are extremely close in similarity, the matching user's badge can be modified to indicate that 95% match (e.g., a filled in scaling out of 100 that is displayed as part of the displayed matching user's badge, for example).

In some embodiments, when the recommendations correspond to recommended matches of other users (and their badges), the badges of the matching users can be ranked and displayed. In some embodiments, the ranking can be in an ascending, descending, random or other criteria-based ordering that corresponds to a similarity value between users. In some embodiments, matches below a threshold value can be filtered out — in some embodiments, the threshold value can be dynamically set and adjusted by the user and/or engine 300.

In some embodiments, ranked recommendations, whether they relate to other users, activities or recommended content, or some combination thereof, are displayed according to the ranking. In some embodiments, the ranking causes the recommended results to be sortable and/or scrollable based on a matching similarity value. In some embodiments, ranked recommendations are ordered so that one (or a set of n) at a time can be displayed/provided. In some embodiments, a user can “swipe left” or “swipe right” to dismiss or approve a recommendation, respectively. In some embodiments, for example, an approved recommendation of a matching user can cause that user to be added as a friend. In some embodiments, for example, an approved activity recommendation causes the activity to be enabled and/or accessible on the user's device (e.g., the user can be logged in and/or afforded the opportunity to login). In some embodiments, for example, a content recommendation that is approved causes the content to be added to a playlist of the user (e.g., a “recommendation” playlist or a playlist associated with an event, and the like).

In Step 610, a selection of at least one recommendation is received. In some embodiments, the user provides a selection by selecting the recommendation on the GUI. In some embodiments, the badge is configured to automatically determine a selection. In some embodiments, badge engine 300 is configured to execute a ML/AI classifier (as discussed above at least in relation to steps 406 and 604-606) to determine which recommendation most similarly matches the input from step 602. In some embodiments, the automatic selection can be performed based on analyzed a user's history, user behavioral information, and/or profile information of the user.

In step 612, engine 300 enables interaction based on the selected recommendation. In some embodiments, an application associated with and/or providing badge functionality of engine 300 is configured to connect to other users, receive and/or render content, and/or establish communication with another platform or service, as configured and enabled/facilitated per the selected recommendation. In some embodiments, the badge of a user, and the application providing the badge, enables a user to discover other users and content, and interact with those users and render such content.

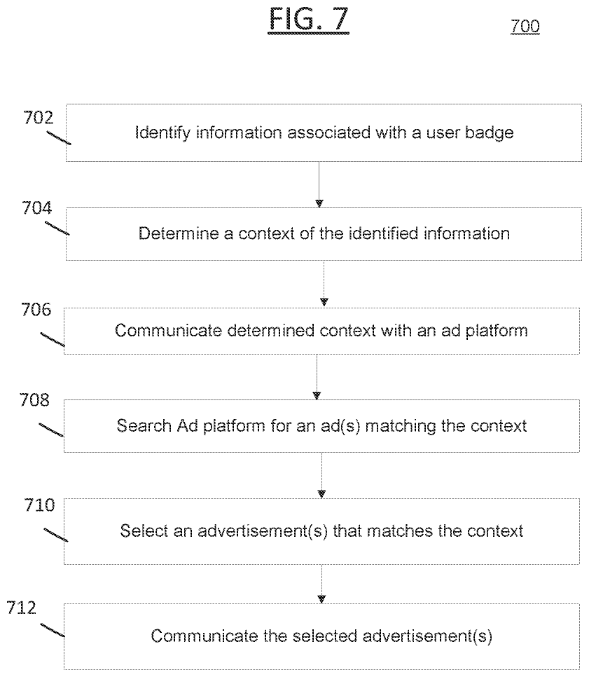

FIG. 7 is a workflow process 700 for serving or providing related digital media content based on a badge of a user according to some embodiments, as discussed above in relation to FIGS. 4-6. For example, a user's badge can indicate they are a girl, age 46, and that they are interested in music by Fleetwood Mac. In some embodiments, this can be leveraged to provide the user with content related to a local concert by the band (e.g., send a link or message enabling the purchase of tickets, for example). In some embodiments, the provided content can be associated with or comprising advertisements (e.g., digital advertisement content).

As discussed above, reference to an “advertisement” should be understood to include, but not be limited to, digital media content that provides information provided by another user, service, third party, entity, and the like. In some embodiments, such digital ad content can include any type of known or to be known media renderable by a computing device (i.e., electronic device), including, but not limited to, video, text, audio, images, and/or any other type of known or to be known multi-media. In some embodiments, the digital ad content can be formatted as hyperlinked multi-media content that provides deep-linking features and/or capabilities. Therefore, while the content is referred as an advertisement, it is still a digital media item that is renderable by a computing device, and such digital media item comprises digital content relaying promotional content provided by a network associated third party.

In step 702, badge information is identified. In some embodiments, this information can be derived, determined, based on, or otherwise identified from the steps of Processes 400 and 600, as discussed above.

In Step 704, a context is determined based on the identified badge information. In some embodiments, this context forms a basis for serving content related to the badge and/or user associated with the badge, as discussed above. In some embodiments, the context can provide an indication of a user's interest and/or identity, and/or acted on recommendations, as discussed above in relation to processes 400 and 600.

In some embodiments, the identification of the context from step 704 can occur before, during and/or after the analysis detailed above with respect to FIGS. 4 and/or 6, or it can be a separate process altogether, or some combination thereof.

In step 706, the determined context is communicated (or shared) with a content providing platform comprising a server and database (e.g., content server 106 and content database 107, and/or advertisement server 130 and ad database). In some embodiments, upon receipt of the context, the server performs (e.g., is caused to perform as per instructions received from the device executing the badge engine 300) a search for a relevant digital content within the associated database. In some embodiments, the search for the content is based at least on the identified context.

In Step 708, the server searches the database for a digital content item(s) that matches the identified context according to some embodiments. In Step 710, a content item is selected (or retrieved) based on the results of Step 708 according to some embodiments.

For example, continuing with the Fleetwood Mac example above, the content item can be a coupon for purchasing a ticket to the concert. In another example, the content item can be a coupon or discount code embedded or deep linked within a message or a provided image of the band in relation to purchasing one of their albums from an online store.

In some embodiments, the selected content item can be modified to conform to attributes or capabilities of a device, browser user interface (UI), video, page, interface, platform, application, or method upon which a user will be viewing their badge, the content item and/or recommendation(s). In some embodiments, the selected content item is shared or communicated via the application or browser the user is utilizing. In some embodiments, the selected content item is sent directly to a user computing device for display on a device and/or within a user interface (UI) displayed on the device's display (e.g., within the browser window and/or within an inbox of a high-security network property). In some embodiments, the selected content item is displayed within a portion of the interface or within an overlaying or pop-up interface associated with a rendering interface displayed on the device.

It should be understood that while the discussion herein generally discusses content being received, personalized, and displayed/rendered on a device, such content can include any type of known or to be known content, such as, but not limited to, webpages, content items on a page, media items, text, graphics, video, images, multimedia objects, advertisements, and the like.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings is part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function in some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable, and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

What is claimed is:

1. A system comprising:
one or more computers comprising one or more processors and one or more non-transitory computer readable media, the one or more non-transitory computer readable media comprising instructions stored thereon that when executing cause the one or more computers to execute steps comprising:
displaying, by the one or more processors, a set of requests related to a user's identity on a graphical user interface (GUI) of a first electronic device;
receiving, by the GUI, one or more responses from a first user;
analyzing, by the one or more processors, the one or more responses;
determining, by the one or more processors, a first badge for the first user, the first badge including a digital representation of the one or more responses; and
displaying, by the one or more processors, the first badge on the first electronic device.

2. The system of claim 1, further comprising:
receiving, by the one or more processors, requested user information;
analyzing, by the one or more processors, the requested user information;
determining, by the one or more processors, one or more recommendations for the first user based on the requested user information;
receiving, by the one or more processors, a selection of at least one of the one or more recommendations; and
determining, by the one or more processors, a start time for the one or more recommendations;
executing, by the one or more processors, a broadcast of a first signal at the start time automatically;
automatically executing, by the one or more processors, a receive configuration for a second signal at the start time;
wherein the first signal comprises information about the first user; and
wherein the second signal comprises second user information.

3. The system of claim 2,
wherein the one or more recommendations includes an event.

4. The system of claim 3,
wherein the event includes at least one of a real-world event, digital event, and a real-world, digital hybrid event.

5. The system of claim 1,
wherein the system is configured to display the first badge on a second user device.

6. The system of claim 1,
wherein the system is configured to broadcast a first signal from the first electronic device.

7. The system of claim 6,
wherein the first signal comprises the first badge.

8. The system of claim 1,
wherein the system is configured to receive a second signal from a second electronic device.

9. The system of claim 8,
wherein the second signal comprises a second badge.

10. The system of claim 9,
wherein the second badge comprises information about a second user.

11. The system of claim 9,
wherein the second badge comprises one or more icons corresponding to one or more second user interests.

12. The system of claim 10,
wherein the information includes a location of the second user.

13. The system of claim 1,
wherein the system is configured to generate and/or interface with a geo-fence.

14. The system of claim 13,
wherein the geo-fence defines a perimeter within which to receive and/or send a signal.

15. The system of claim 14,
wherein the signal comprises an instance of a badge.
